(19) United States
(12) Patent Application Publication
(10) Pub. No.: US 2013/0346860 A1
(43) Pub. Date: Dec. 26, 2013

(54) MEDIA COMPLIATION SYSTEM

(71) Applicant: NB Corp Ltd., Surrey (GB)

(72) Inventor: Niall Buggy, Surrey (GB)

(21) Appl. No.: 13/922,870

(22) Filed: Jun. 20, 2013

(30) Foreign Application Priority Data
Jun. 20, 2012 (GB) GB 1210914.6

(51) Int. Cl. G06F 3/0484

(52) U.S. Cl. CPC G06F 3/0484
USPC 715/716

(57) ABSTRACT

A media compilation system is disclosed. A user interface enables creating or receiving of a profile comprising a time-ordered sequence of blocks, each block having associated timing and audio attribute parameters. A music piece is assigned to each block of the profile in dependence on the timing and audio attributes of the block and timing and audio metadata of the music pieces.

### FIELD OF THE INVENTION

The present invention relates to a media compilation system and a computer implemented media compilation method that are particularly applicable to compilation and management of media for playlists.

### BACKGROUND OF THE INVENTION

Until recently, media compilation was something performed by artists and broadcast or producing studios. Whether provided as a broadcast or as a sold CD, DVD, MP3 album, a media compilation was something that a user experienced in an order determined by the producers.

Since the advent of digital media players such as MP3 players and mobile phones that include such functionality, freedom to pick and choose individual tracks of an album or the like has changed the way media is consumed. A similar trend is taking place on television with on demand services displacing traditional scheduled broadcasts.

However, despite the shift of control to the consumer of the media, producing good compilations of media is not something that is easy for the average person to do. While there are many fields of use where a disjointed or mismatched compilation will not spoil the experience of consuming the compilation, there are other fields of use where such faults are noticeable and problematic.

Current compilation systems in music systems enable creation of playlists. Typically, a user is able to interact with his or her current music library and create a custom playlist by selecting and order music tracks to be played. When the playlist is later selected by the user, the tracks are played in the specified order.

The limits to which a compilation can be personalised resulted in compilations having a typically short lifetime as a user would not wish to watch or listen to the same compilation over and over again. However, few users had the time or ability to create their own compilations.

### SUMMARY OF THE INVENTION

According to an aspect of the present invention, there is provided a media compilation system comprising a processor arranged to receive user inputs on a compilation profile via a user interface device, the processor being arranged to analyze the profile to generate and output a sequence of media pieces from a media data repository having attributes fitting the profile.

Selected embodiments of the present invention are particularly applicable to use in fitness classes or by athletes and fitness enthusiasts who like to listen to music whilst training. In particular, embodiments enable prescribed routines to be defined in a manner that the underlying music can be interchanged. In such a manner, a class or exercise routine having a particular effort profile can be customised based either on music in the user's personal library or optionally by purchase of new tracks from a remote source. In choreographed classes, this means that the choreography can be separated from the music and that different music tracks can be substituted to suit the instructor's or classes taste. Additionally, the lifetime of a routine can be extended by substituting different tracks when the class becomes bored or fatigued by those originally specified.

In a further embodiment, routines can themselves be customised so as to add variation, change difficulty or profile. Where necessary, a change to the routine may also trigger a change to the associated music track(s).

Preferred embodiments enable management of time, speed and music tracks in a compilation. They may also enable users to build and share profiles of a compilation with or without links to the underlying music tracks. Optionally, embodiments may enable a received profile to be automatically matched to music tracks in the user's library. Profiles can optionally be created using attributes of music such as beats per minutes (BPM), key, and chord sequence, etc.

### BRIEF DESCRIPTION OF THE DRAWINGS

An example of the present invention will now be described by way of example only, with reference to the accompanying drawings, in which:

FIG. 1 is a schematic diagram of a music compilation system according to an embodiment of the present invention.

FIG. 2 is a screen shot of an example user interface for creating a profile according to an embodiment;

FIG. 3 is a screen shot of an example user interface showing a portion of a library and associated metadata; and,

FIGS. 4 to 7 are screen shots of aspects of a user interface for manipulating a profile according to an embodiment.

### DETAILED DESCRIPTION

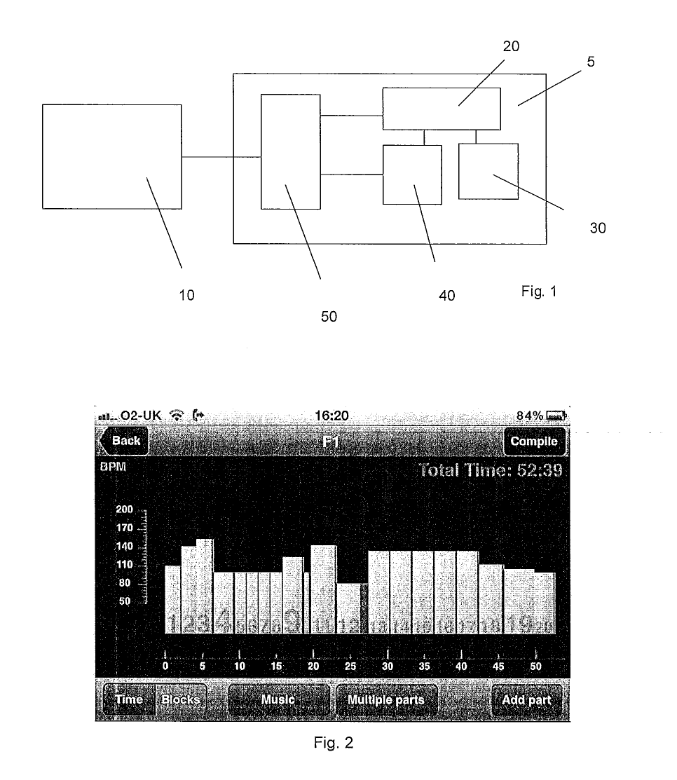

FIG. 1 is a schematic diagram of a music compilation system according to an embodiment of the present invention.

The music compilation system 5 includes a media data repository 10, a processor 20, a memory 30, a user interface device 40 and an input/output interface 50.

A media management program is encoded in the memory and is executed by the processor to provide a user interface via the user interface device.

The media data repository encodes multiple media pieces such as music tracks. Preferably, the media pieces have been pre-processed by the music compilation system (or by some other system) so as to have metadata associated with them in the repository or in an associated database. The metadata preferably includes timing and audio (and optionally visual) attributes for the media piece. The following discussion focusses on music tracks as media pieces, although it will be appreciated that other forms of media pieces could be readily substituted or intermixed with music tracks.

The user interface enables users to build and share profiles of a compilation and match music tracks to these profiles. Profiles can be created using attributes of music such as beats per minutes (BPM), key, and chord sequence, etc.

For example, a profile may be for an exercise class such as aerobics, spinning or the like.

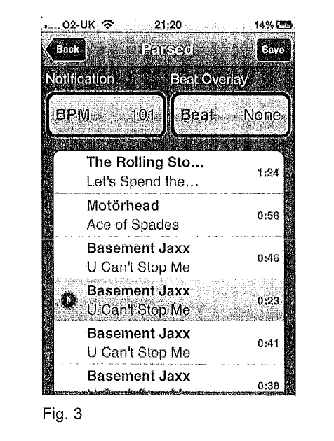

The user is able, via the user interface, to create a profile (or select a pre-created profile) via a graphical user interface (GUI) as illustrated in FIG. 2, or via another method such as text entry.

Preferably, the user interface device 40 is a touch screen display and the user is able to ‘draw’ a profile to create it or edit it on-screen. In the example illustrated in FIG. 2, a user draws a profile on axes representing time (x) and the musical attribute (y), e.g. BPM. The user can divide the profile into parts—each part can have different time and musical attributes.

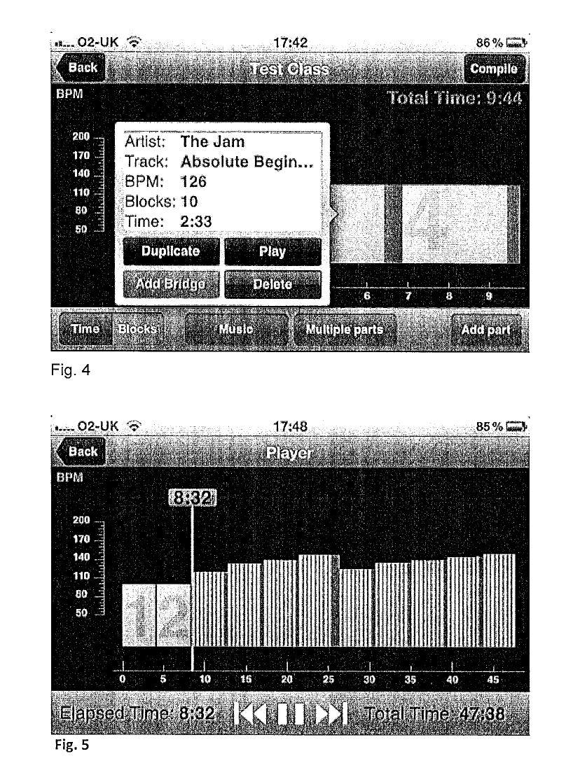

The processor is arranged to analyze the profile (either as drawn or when requested by the user) to determine music tracks from the media data repository 10 that best fits the time and music attributes for the part, as shown in FIG. 3. Multiple options may be offered to the user, for example tracks fitting the profile within predetermined tolerance values may be offered such that the user can in certain circumstances select a sub-optimal track or one of two or more closely tracks. Optionally, the processor may auto select tracks for the part, based on best fit or other preferences such as artist.

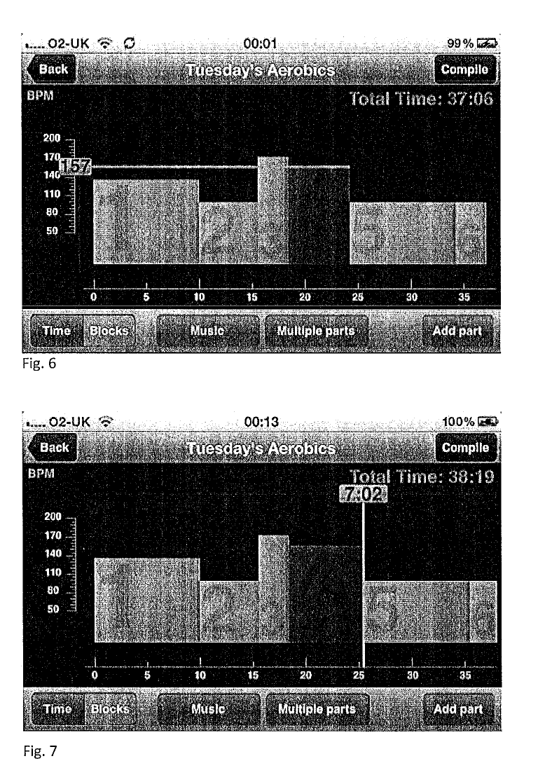

The user interface may optionally provide functions for manipulating a profile as illustrated in FIGS. 4 to 7. In FIG. 4, attributes of a track assigned to a profile block are shown with options to play the track, delete it, duplicate it or add a bridging piece between one track and another. In FIGS. 5, 6 and 7 various user interface views of profiles are shown. In FIG. 5, blocks are segmented into sub-sections. In FIGS. 6 and 7, screen displays during a profile editing operation are shown. In FIG. 6 the BPM profile of the selected block is changed to 157 while in FIG. 7, the time for that block is changed to 7 minutes 2 seconds. It will be appreciated that these edits could be implemented in many ways, although preferably they are done via touch inputs to a touch screen.

When the user has completed the profile they can save it either locally or remotely (optionally publishing it for others to access and/or purchase via a shared repository or store). This allows the user to share the profile separately to the music tracks with other people via the Internet or mobile phone message services. The profile may include links to the music tracks (for example to an associated record in a music indexing site so as to facilitate matching to another person's own library, an online digital music store enabling purchase, etc.).

On demand, the media compilation system 5 can generate a compilation according to a selected profile by accessing the associated music from the user's library and joining the tracks together into a combined digital media file such that the compilation can be played from start to finish in the order set by the profile. It may be that the digital media file is an MP3 (or similar) digital music file or it may be some protected data format in which the tracks are stored in a carrier alongside a data file encoding the profile.

During editing of a profile, if the user adjusts the x or y-axis attributes of a part in the profile, the system is arranged to either suggest new music to fit the adjusted part, or augment the chosen music to ‘fit’ the new parameters (e.g. play it a at a calculated faster tempo in BPM is increased).

As discussed above, a user can optionally share a profile via an Internet market place or mobile messaging (e.g. SMS). The sharer can select to share the profile with or without the music (this assumes necessary music publishing permissions are in place). The sharee can download the shared profile and music onto their device to play. If no music is downloaded, the sharee can select their own music for each part in the class or have the solution automatically select the music for them.

The user can ‘run’ the class, which will play the music selected for the profile.

Detailed example using BPM as the music attribute
a. Parse music library
   i. Select song or songs from a mobile phone or computer based music library.
   ii. Analyze each song in library for a BPM (or other given property based on an algorithm, e.g. musical key). An example algorithm is described in iii to v.
   iii. Evaluate beat energy function in every point of track. These stages are passed by initial signal of a track sequentially:
      a. Short time Fourier transform—going to time-frequency domain.
      b. FIR-filter—finite impulse response filter calculates energy flux (derivative of signal in distinct channel). This energy flux is represents the beat probability (in some sense).
      c. Threshold function—applied to eliminate low-level signal, where no beat is located (noise).
      d. Low-pass filter—applied to make next stages more robust.
   iv. Estimate BPM (takes the output of previous algorithm as input):
      a. Autocorrelation function—calculates probability of distinct interbeat space.
      b. Maximizing—finds the most probable interbeat space.
      This space value is used to calculate BPM.
   v. Split track into fragments with steady BPM (takes the output of the first algorithm as input). For each interbeat space:
      a. Split input into pieces that are proportional to interbeat space.
      b. Calculate autocorrelation function value on this piece.
      c. All pieces in sequence where autocorrelation function is rather high form the candidate of fragment.
      d. After all candidates of fragment are obtained, filter them—fragments should not interleave. Candidates with lowest unit autocorrelation are filtered out.
   vi. Record the start and end points of each section where the BPM remains constant (within predefined tolerances), the (time) length of the section and the value of the property, e.g. 128 BPM.
   vii. Record a copy of each section on the same device and/or the data of that section (from vi).
b. Create a profile of a “class”
   i. Using either text or a graphical user interface (GUI), like the one shown in FIG. 2, the user can create a class profile by adding parts. Each part represents time (x-axis) and the property, e.g. BPM (y-axis). These parameters can be adjusted to the user's requirements.
   ii. Time can be shown as minutes and seconds or pre-defined blocks (e.g. 32 beats).
   iii. The user can save the profile of the class at this point, or add music to it as described in section c.
c. Select music for a part
   i. Once the user has created a part they will then be able to open their stored library (created in section a).
   ii. The library will list the sections of music that best suits the part's parameters such as BPM and/or time.
   iii. The user can then select a section of music. This will be saved against that part in the class. See example in FIG. 2.
d. The user can select to overlay additional pre-recorded sounds to enhance a parameter. E.g. drum sounds at each beat to enhance BPM.
e. The user can select and save pre-recorded video segments with the class to be shown at specific times during the playback of the class.
f. Compile class
   i. When the user is finished editing the class, they can “compile” this to create a single file.
   ii. The compiled file can contain the profile of the class (see section b) and/or one or all of the following: the music selected for the parts of the class (see section c); the videos selected for the class (see section e).
g. Sharing profiles
   i. Users may be able to upload their class profile file to Internet based sharing forums (e.g. web site or social media site).
   ii. Users may also be able to share files directly via e-mail or other electronic messaging formats.
   iii. Users may be able to share their profile, music and video content (depending on the relevant licensing requirements).
   iv. Where one user shares a profile without music with another user, the receiving user will be able to select music, or video, for that profile as described in section c.
   v. Users can optionally charge for the downloading of their profiles from Internet websites and/or receive commission for sale of the music tracks used in the profile when purchased from an affiliated online music store.
h. Playback of class
   i. A user will be able to “play” a class on their mobile phone or other music playback device.
   ii. The playback will play all the compiled music and video content as defined in sections c, d, e and f according to the profile.

It is to be appreciated that certain embodiments of the invention as discussed below may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Optional embodiments of the invention can be understood as including the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although illustrated embodiments of the present invention have been described, it should be understood that various changes, substitutions, and alterations can be made by one of ordinary skill in the art without departing from the present invention which is defined by the recitations in the claims below and equivalents thereof.

1. A computer implemented music compilation system comprising:
a data repository encoding a plurality of music pieces, each music piece having associated timing metadata on timing of the music piece and audio metadata on audio attributes of the music piece; and,
a processor configured to execute computer program code for providing a user interface for creating a profile comprising a time-ordered sequence of blocks, including assigning associated timing and audio attribute parameters for each block, the processor being further configured to execute computer program code to assign a music piece from the data repository to each block of the profile in dependence on the timing and audio attributes of the block and timing and audio metadata of the music pieces.

2. The system of claim 1, further comprising a touch screen display, the processor being configured to execute the computer program code to provide the user via the touch screen display including executing computer program code to manipulate a graphical representation of a profile on the touch screen in response to touches by the user on the touch screen.

3. The system of claim 2, the processor being further configured to execute computer program code to graphically represent the profile in 2-dimensions, a first dimension corresponding to timing and a second dimension corresponding to the audio attribute.

4. The system of claim 1, wherein the processor is further configured to execute computer program code to analyze the profile to assign a music piece in the data repository that has timing and audio metadata that most optimally fit the time and music attributes for the block.

5. The system of claim 4, wherein the processor is further configured to execute computer program code to present a number of music pieces to the user via the user interface for assignment of one of the music pieces to the block, the number of music pieces having metadata that most optimally fit the time and music attributes of the block.

6. The system of claim 5, wherein the processor is further configured to execute computer program code to adjust a measure of optimal fit in dependence on a tolerance value, the tolerance value extending a range of music pieces that are determined to optimally fit the block.

7. The system of claim 1, wherein the processor is configured to execute computer program code to encode a representation of the profile in a data store, the representation encoding the time-ordered sequence of the blocks and the associated timing and audio attribute parameters for each block.

8. The system of claim 7, wherein the processor is further configured to execute computer program code to encode, in the representation of the profile in the data store, a data link in the data repository to each assigned music piece.

9. The system of claim 7, wherein the processor is further configured to execute computer program code to encode, in the representation of the profile in the data store, a data link to each assigned music piece, each data link directing the user to a commercial online music system.

10. The system of claim 1, wherein the processor is further configured to execute computer program code to adjust assignment of one or more of the music pieces in response to editing of the profile by the user.

11. The system of claim 1, wherein the processor is further configured to execute computer program code to cause playing of the assigned music pieces in the time ordered sequence of the profile.

12. A media compilation system comprising:
a processor configured to execute computer program code for providing a sequence of media pieces, the computer program code including:
computer program code configured to receive user inputs on a compilation profile via a user interface device; and,
computer program code to analyze the compilation profile to generate and output a sequence of media pieces from a media data repository having attributes fitting the profile.

13. A computer implemented music compilation system comprising:
a data repository encoding a plurality of music pieces, each music piece having associated timing metadata on timing of the music piece and audio metadata on audio attributes of the music piece; and,
a processor configured to execute computer program code for receiving data encoding a profile comprising a time-ordered sequence of blocks and associated timing and audio attribute parameters for each block, the processor being further configured to execute computer program code to assign a music piece from the data repository to each block of the profile in dependence on the timing and audio attributes of the block and timing and audio metadata of the music pieces.

14. The system of claim 13, wherein the data encoding the profile designates a music piece assigned to each block.

15. The system of claim 14, wherein the processor is further configured to execute computer program code to accept user inputs to customise the profile by substituting one or more of the assigned music pieces for other music pieces in the data repository.

16. The system of claim 13, wherein the processor is further configured to execute computer program code to accept user inputs to customise the profile by purchasing one or more music pieces from an online music store, downloading the one or more music pieces to the data repository and substituting one or more of the assigned music pieces for the one or more purchased music pieces.

17. The system of claim 14, wherein the processor is further configured to execute computer program code to automatically assign a music piece from the data repository to each block.
